(19) United States
(12) Patent Application Publication
(10) Pub. No.: US 2026/0289749 A1
(43) Pub. Date: Sep. 24, 2026

(54) IMAGE PROCESSING APPARATUS, IMAGE PROCESSING METHOD, AND PROGRAM

(71) Applicant: FUJIFILM Corporation, Tokyo (JP)

(72) Inventors: Misaki GOTO, Kanagawa (JP); Masaaki OOSAKE, Kanagawa (JP)

(73) Assignee: FUJIFILM Corporation, Tokyo (JP)

(21) Appl. No.: 19/567,244

(22) Filed: Mar. 15, 2026

(30) Foreign Application Priority Data
Mar. 24, 2025 (JP) 2025-048478

(51) Int. Cl. G06T 5/70; G06T 5/50; G06T 5/60; G06V 10/74

(52) U.S. Cl. CPC G06T 5/70; G06T 5/50; G06T 5/60; G06V 10/761; G06T 2207/20081

(57) ABSTRACT

Provided are an image processing apparatus, an image processing method, and a program that suppress occurrence of artifacts or the like in a processed image caused by use of a learning model. An image processing apparatus performs first processing, which does not use a trained learning model, on first image data to generate second image data, performs second processing, which includes processing to which the trained learning model is applied, on the first image data to generate third image data, compares similarity or dissimilarity between the first image data and the third image data, and replaces, in the third image data, a non-similar pixel whose similarity to the first image data is smaller than a criterion or whose dissimilarity from the first image data is greater than the criterion, with a pixel at a position corresponding to the non-similar pixel in the second image data.

### CROSS-REFERENCE TO RELATED APPLICATION

The present application claims priority under 35 U.S.C § 119(a) to Japanese Patent Application No. 2025-048478 filed on Mar. 24, 2025, which is hereby expressly incorporated by reference, in its entirety, into the present application.

### BACKGROUND OF THE INVENTION

### 1. Field of the Invention

The present invention relates to an image processing apparatus, an image processing method, and a program.

### 2. Description of the Related Art

An endoscope apparatus can examine the inside of the body of the subject in real time by inserting a scope into the body of the subject, imaging the inside of the body of the subject using a camera at a distal end of the scope, and displaying a captured image on a monitor. An operator visually recognizes the monitor while operating the scope, and performs diagnosis and treatment in a case where a lesion or the like is found.

As described above, since the operator performs observation, diagnosis, and treatment by relying on the captured image displayed on the monitor, it is desired to improve the image quality of the captured image displayed on the monitor and reduce noise.

The scope provided in the endoscope apparatus has a size restriction of an image sensor or the like due to insertion into the body, and it is difficult to take measures for improving image quality and measures for reducing noise for hardware. Accordingly, the image processing is performed on imaging data, and the image quality enhancement and the noise reduction of the captured image are realized.

WO2022/163440A discloses an information processing apparatus that executes noise adjustment on a captured image by performing synthesis processing between a first image acquired by executing noise adjustment processing by applying an AI method to the captured image and a second image acquired by executing noise adjustment processing on the captured image without applying the AI method. AI is an abbreviation for artificial intelligence.

### SUMMARY OF THE INVENTION

However, in recent years, processing such as the image quality enhancement and the noise reduction of a captured image has been realized by using a trained learning model obtained through deep learning or the like, but the occurrence of artifacts such as color shift and structural collapse has become a problem.

In the apparatus disclosed in WO2022/163440A, the first image on which the noise adjustment processing is performed by applying the AI method has the above-described problems. WO2022/163440A does not disclose the problem of occurrence of an artifact, and does not disclose a constituent element for solving the problem.

In the above, by taking an endoscopic image as an example, the problem of occurrence of artifacts such as color shift and structural collapse in the image data processed using the trained learning model has been described, but such a problem is not limited to the endoscopic image. For example, regarding processing performed on image data acquired by using an imaging apparatus comprising an image sensor by using a trained learning model, the same type of problem also exists.

The present invention has been made in view of such circumstances, and an object of the present invention is to provide an image processing apparatus, an image processing method, and a program that suppress occurrence of artifacts or the like in a processed image caused by use of a learning model.

An image processing apparatus according to a first aspect of the present disclosure is an image processing apparatus comprising a processor, in which the processor is configured to: perform first processing, which does not use a trained learning model, on first image data to generate second image data; perform second processing, which includes processing to which the trained learning model is applied, on the first image data to generate third image data; compare similarity or dissimilarity between the first image data and the third image data; and replace, in the third image data, a non-similar pixel whose similarity to the first image data is smaller than a criterion or whose dissimilarity from the first image data is greater than the criterion, with a pixel at a position corresponding to the non-similar pixel in the second image data.

An image processing apparatus according to a second aspect is the image processing apparatus according to the first aspect, in which the processor may be configured to compare similarity or dissimilarity between the first image data and the third image data based on a pixel-wise difference between the first image data and the third image data.

An image processing apparatus according to a third aspect is the image processing apparatus according to the second aspect, in which the processor may be configured to perform fourth processing of applying a prescribed threshold value to the difference between the first image data and the third image data, and compare similarity or dissimilarity between the first image data and the third image data based on the difference subjected to the fourth processing.

An image processing apparatus according to a fourth aspect is the image processing apparatus according to any one of the first to third aspects, in which the processor may be configured to, as the second processing, apply a first learning model as the learning model to generate fourth image data from the first image data, and remove a component corresponding to the fourth image data from the first image data to generate the third image data.

An image processing apparatus according to a fifth aspect is the image processing apparatus according to the fourth aspect, in which the processor may be configured to generate noise image data in which a noise component is extracted from the first image data as the fourth image data, and generate the third image data by removing a component corresponding to the noise image data from the first image data.

An image processing apparatus according to a sixth aspect is the image processing apparatus according to any one of the first to third aspects, in which the processor may be configured to apply a second learning model as the learning model to generate the third image data from the first image data.

An image processing apparatus according to a seventh aspect is the image processing apparatus according to the sixth aspect, in which the processor may be configured to apply the second learning model to generate the third image data from which a noise component is removed from the first image data.

An image processing apparatus according to an eighth aspect is the image processing apparatus according to any one of the first to fifth aspects, in which the processor may be configured to apply a third learning model to generate the third image data in which blur is restored from the first image data.

An image processing apparatus according to a ninth aspect is the image processing apparatus according to any one of the first to eighth aspects, in which the processor may apply filter processing as the first processing.

An image processing apparatus according to a tenth aspect is the image processing apparatus according to any one of the first to ninth aspects, in which the processor may apply RAW image data as the first image data.

An image processing method according to an eleventh aspect of the present disclosure is an image processing method executed by a computer functioning as an image processing apparatus including a processor, the method comprising: a step of performing first processing, which does not use a trained learning model, on first image data to generate second image data; a step of performing second processing, which includes processing to which the trained learning model is applied, on the first image data to generate third image data; a step of comparing similarity or dissimilarity between the first image data and the third image data; and a step of replacing, in the third image data, a non-similar pixel whose similarity to the first image data is smaller than a criterion or whose dissimilarity from the first image data is greater than the criterion, with a pixel at a position corresponding to the non-similar pixel in the second image data.

The configuration requirements of the image processing apparatus according to the second to tenth aspects can be applied as configuration requirements of the image processing method according to other aspects.

A program according to a twelfth aspect of the present disclosure is a program that causes a computer functioning as an image processing apparatus including a processor to realize: a function of performing first processing, which does not use a trained learning model, on first image data to generate second image data; a function of performing second processing, which includes processing to which the trained learning model is applied, on the first image data to generate third image data; a function of comparing similarity or dissimilarity between the first image data and the third image data; and a function of replacing, in the third image data, a non-similar pixel whose similarity to the first image data is smaller than a criterion or whose dissimilarity from the first image data is greater than the criterion, with a pixel at a position corresponding to the non-similar pixel in the second image data.

The configuration requirements of the image processing apparatus according to the second to tenth aspects can be applied as configuration requirements of a program according to other aspects.

According to the present disclosure, the occurrence of artifacts or the like in the processed image caused by the use of the learning model is suppressed.

### BRIEF DESCRIPTION OF THE DRAWINGS

FIG. 1 is a functional block diagram showing a configuration example of an image processing apparatus according to a first embodiment.

FIG. 2 is a schematic diagram showing an example of denoise image generation processing.

FIG. 3 is a schematic diagram showing an example of similarity comparison processing.

FIG. 4 is a schematic diagram of contraction and expansion processing.

FIG. 5 is a schematic diagram showing an example of pixel replacement processing.

FIG. 6 is a flowchart showing a procedure of an image processing method according to the first embodiment.

FIG. 7 is a functional block diagram showing a configuration example of an image processing apparatus according to a second embodiment.

FIG. 8 is a flowchart showing a procedure of an image processing method according to a second embodiment.

FIG. 9 is a functional block diagram showing a configuration of an image processing apparatus according to a third embodiment.

FIG. 10 is a block diagram showing an example of a hardware configuration of the image processing apparatus.

### DESCRIPTION OF THE PREFERRED EMBODIMENTS

Hereinafter, a preferred embodiment of the present invention will be described in detail with reference to the accompanying drawings. In the present specification, the same constituent elements are designated by the same reference numerals, and duplicate description thereof will be omitted as appropriate. In addition, in the following embodiment, in a case in which a plurality of constituent elements are described and listed, it can be interpreted that at least one of the plurality of constituent elements is included.

### Configuration Example of Image Processing Apparatus According to First Embodiment

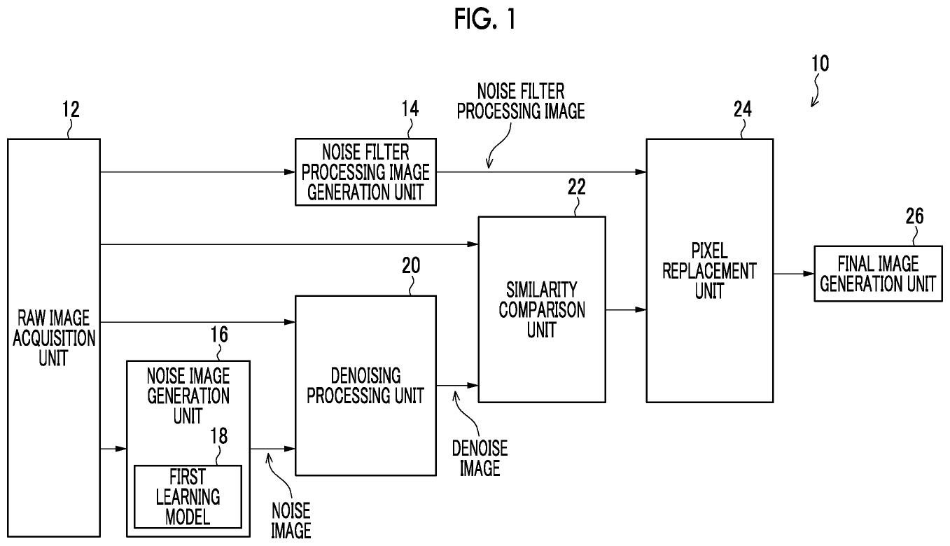

FIG. 1 is a functional block diagram showing a configuration example of an image processing apparatus according to a first embodiment. An image processing apparatus 10 estimates a noise distribution for an original RAW image using a trained learning model to which deep learning such as CNN is applied, and generates a denoise image by subtracting the noise distribution from the RAW image. CNN is an abbreviation for convolutional neural network.

However, the denoise image in which the processing of the trained learning model is included in the generation process may have artifacts such as color shift and structural collapse. Therefore, the image processing apparatus 10 estimates an artifact region in which an artifact occurs in the denoise image from pixel-wise differences between the RAW image and the denoise image generated from the RAW image, and replaces pixels of the artifact region with pixels of a noise filter processing image generated by applying noise removal filter processing such as a Gaussian filter. Pixels of the denoise image are used as they are in a normal region other than an artifact region in the denoise image.

The RAW image represents image data that is not in a completed state as an image in which pixels are arranged in a two-dimensional or three-dimensional manner. The RAW image may be unprocessed data for imaging data of the subject acquired by using the imaging apparatus.

Here, the term “image” in the present specification may include the meaning of image data, which means a signal representing an image, and data referred to as image signals or the like.

The image processing apparatus 10 comprises a RAW image acquisition unit 12. The RAW image acquisition unit 12 acquires a RAW image from an imaging apparatus comprising an image sensor. The RAW image acquisition unit 12 may acquire the RAW image stored in an external device such as an image storage device.

An example of the imaging apparatus comprising the image sensor is a camera at a distal end of a scope provided in an endoscope apparatus. The RAW image may be an output signal of the image sensor.

The image processing apparatus 10 comprises a noise filter processing image generation unit 14. The noise filter processing image generation unit 14 performs noise removal processing in which a noise removal filter is applied to a RAW image, and generates a noise filter processing image. The noise removal processing to which the noise removal filter is applied is an example of first processing according to the present disclosure, and is an example of the first processing that does not use a learning model.

The image processing apparatus 10 comprises a noise image generation unit 16. The noise image generation unit 16 comprises a first learning model 18. The trained first learning model 18 is trained and generated such that, in a case where the RAW image is input, a noise image representing a noise distribution of the RAW image is output. The first learning model 18 is applied with a learning model to which deep learning such as a CNN is applied.

The noise image generation processing to which the trained first learning model 18 is applied may be an example of a constituent element of second processing of the same type as the first processing of the present disclosure.

The image processing apparatus 10 comprises a denoising processing unit 20. The denoising processing unit 20 generates a denoise image in which the noise component is removed from the RAW image by subtracting the noise distribution of the RAW image represented by the noise image from the RAW image. The denoising processing unit 20 calculates pixel-wise differences of pixel values between the RAW image and the noise image.

Here, the pixel of the RAW image is a constituent element of a signal representing the RAW image, and is a unit of a signal representing the RAW image corresponding to a pixel in an image in which pixels are arranged in a two-dimensional or three-dimensional manner. The pixel value is a signal value for each unit of the signal. The denoising processing unit 20 is an example of a processing unit that generates third image data by removing a component corresponding to the noise image data from the first image data of the present disclosure. The denoise image generation processing is an example of a constituent element of the second processing of the present disclosure.

The image processing apparatus 10 comprises a similarity comparison unit 22. The similarity comparison unit 22 compares similarity between the RAW image and the denoise image. That is, the similarity comparison unit 22 estimates, as an artifact region, a region in which pixel-wise differences of pixel values between the RAW image and the denoise image are relatively large. The similarity comparison unit 22 may compare dissimilarity between the RAW image and the denoise image, and may estimate, as a pixel of the artifact region, a pixel whose dissimilarity is greater than a criterion. A pixel whose dissimilarity between the two is greater than a criterion may be a pixel whose dissimilarity is equal to or greater than the criterion, or may be a pixel whose dissimilarity exceeds the criterion.

The image processing apparatus 10 comprises a pixel replacement unit 24. The pixel replacement unit 24 performs processing of replacing the pixel of the artifact in the denoise image with the pixel of the artifact corresponding region in the noise filter processing image, which corresponds to the artifact of the denoise image.

The processing of replacing a pixel of the artifact region in the denoise image with a pixel of an artifact corresponding region in the noise filter processing image is an example of processing of replacing a non-similar pixel, whose similarity to first image data of the present disclosure is less than the criterion, with a pixel at a position corresponding to the non-similar pixel in second image data. The pixel of the artifact region in the denoise image is an example of a non-similar pixel of the present disclosure.

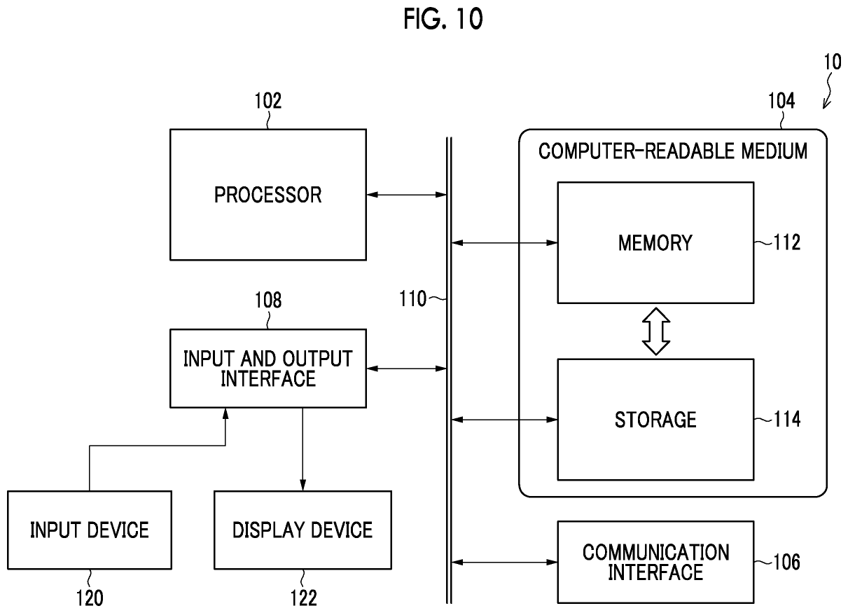

The image processing apparatus 10 comprises a final image generation unit 26. The final image generation unit 26 generates the final image from data in which the pixel of the artifact region in the denoise image is replaced with the pixel of the artifact corresponding region of the noise filter processing image. The final image may be displayed on a monitor or stored in the image storage device. An example of a monitor that displays the final image is a display device connected to a computer functioning as the image processing apparatus 10. The monitor is shown as a display device 122 in FIG. 10.

### Specific Example of Denoise Image Generation

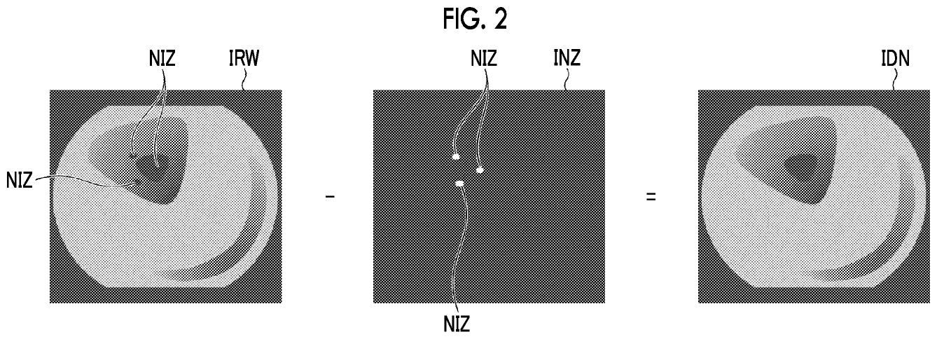

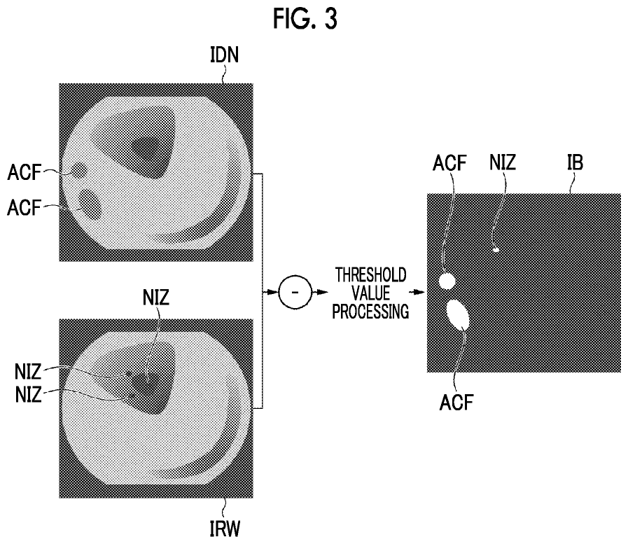

FIG. 2 is a schematic diagram showing an example of denoise image generation processing. The noise image generation unit 16 and the denoising processing unit 20 shown in FIG. 1 are applied to the denoise image generation processing shown in FIG. 2. FIG. 2 shows an example of an endoscopic image obtained by imaging the inside of the body of the subject using an endoscope. The same applies to FIGS. 3 to 5.

A RAW image IRW shown in FIG. 2 is acquired by using the RAW image acquisition unit 12 in FIG. 1. The RAW image IRW includes a noise component NIZ. The pixels constituting the noise component NIZ change rapidly in pixel value with respect to pixels around the noise component NIZ.

The noise image INZ is generated by using the noise image generation unit 16 in FIG. 1. The noise image INZ represents the distribution of the noise component NIZ in the RAW image IRW.

The denoise image IDN is generated by using the denoising processing unit 20 in FIG. 1. The noise image INZ generated by using the trained first learning model 18 may include artifacts such as color shift and structural collapse. Accordingly, artifacts similar to those in the noise image INZ may also occur in the denoise image IDN generated by subtracting the noise image INZ from the RAW image IRW.

In the noise image INZ and the denoise image IDN shown in FIG. 2, the artifacts are not shown. The artifacts in the denoise image IDN are schematically shown as an artifact region ACF in the denoise image IDN shown in FIG. 3.

The RAW image is an example of first image data of the present disclosure and is an example of RAW image data. The noise filter processing image is an example of second image data of the present disclosure. The denoise image is an example of third image data of the present disclosure. The noise image INZ is an example of fourth image data of the present disclosure and is an example of noise image data.

### Specific Example of Similarity Comparison Processing

FIG. 3 is a schematic diagram showing an example of similarity comparison processing. The similarity comparison unit 22 shown in FIG. 1 is applied to the similarity comparison processing shown in FIG. 3. In the similarity comparison processing, pixel-wise differences between the RAW image IRW that includes the noise component NIZ and the denoise image IDN that includes the artifact region ACF representing an artifact are extracted. In the similarity comparison processing, threshold value processing in which a prescribed threshold value is applied to the differences is executed pixel by pixel, and pixels having pixel values equal to or greater than the prescribed threshold value are extracted. That is, in the similarity comparison processing, the artifact region ACF and the noise component NIZ having a relatively large intensity are estimated as a region composed of the pixels having the pixel value equal to or greater than the prescribed threshold value. The threshold value processing for the pixel-wise difference between the RAW image IRW and the denoise image IDN is an example of fourth processing of the present disclosure.

In FIG. 3, the artifact region ACF estimated from the difference between the denoise image IDN and the RAW image IRW and the noise component NIZ having a relatively large intensity are schematically shown as a binarized image IB. In the binarized image IB shown in FIG. 3, white pixels represent the artifact region ACF and the noise component NIZ.

The similarity comparison processing is not limited to the threshold value processing for the pixel-wise difference between the denoise image IDN that includes the artifact region ACF and the RAW image IRW. For example, a region in which a division value of pixel-wise pixel values between the RAW image IRW and the denoise image IDN changes extremely largely, or a region in which the division value changes extremely small, may be estimated as an artifact region ACF.

In addition, each of the RAW image IRW and the denoise image IDN may be divided into a plurality of small regions, and the small region in which the value of the image correlation between the regions corresponding to each other is relatively low may be estimated as the artifact region ACF.

### Specific Example of Contraction and Expansion Processing

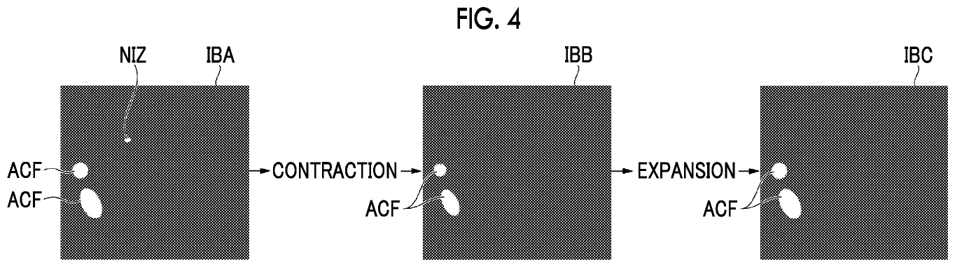

FIG. 4 is a schematic diagram of contraction and expansion processing. FIG. 4 schematically shows each step of the contraction and expansion processing. In FIG. 4, similarly to the binarized image IB shown in FIG. 3, a black-and-white binarized image IBA, which is represented by the artifact region ACF and the noise component NIZ, is shown.

As in the binarized image IBA, in the random noise included in the RAW image IRW shown in FIG. 3 or the like, noise having a relatively large difference from the denoise image IDN shown in FIG. 3 may be present. Such relatively large noise may be extracted as a region in which the difference between the RAW image IRW and the denoise image IDN exceeds a threshold value in the similarity comparison processing.

As an example of processing for the purpose of removing the noise constituent elements extracted as the outliers, the contraction and expansion processing is used. FIG. 4 shows a binarized image IBB which represents a result of the contraction processing on the denoise image IDN including the artifact region ACF and the noise component NIZ.

In a case where black pixels are present in the vicinity of the white pixel to be converted, the white pixel to be converted is converted into a black pixel. In the contraction processing, all the noise constituent elements NIZ shown as white pixels in the binarized image IBA are removed. On the other hand, in the contraction processing, the area of the artifact region ACF is reduced.

FIG. 4 schematically shows a binarized image IBC representing a result of the expansion processing performed after the contraction processing. In the expansion processing, in a case where white pixels are present in the vicinity of the black pixel to be converted, the black pixel to be converted is converted into a white pixel. In the expansion processing, the artifact region ACF whose area is reduced in the binarized image IBB is restored to the original area, as in the artifact region ACF in the binarized image IBA.

In this way, in a case where the processing is performed in the order of the reduction processing and then the expansion processing, the region having a very small area such as one pixel is converted from the white pixel to the black pixel, the noise component NIZ extracted as an outlier is removed, and only the regional artifact region ACF having a certain area is extracted.

The above-described processing is not limited to an aspect in which one reduction processing and one expansion processing are performed. For example, opening in which the contraction processing and the expansion processing are repeatedly performed a plurality of times may be performed.

### Specific Example of Pixel Replacement Processing

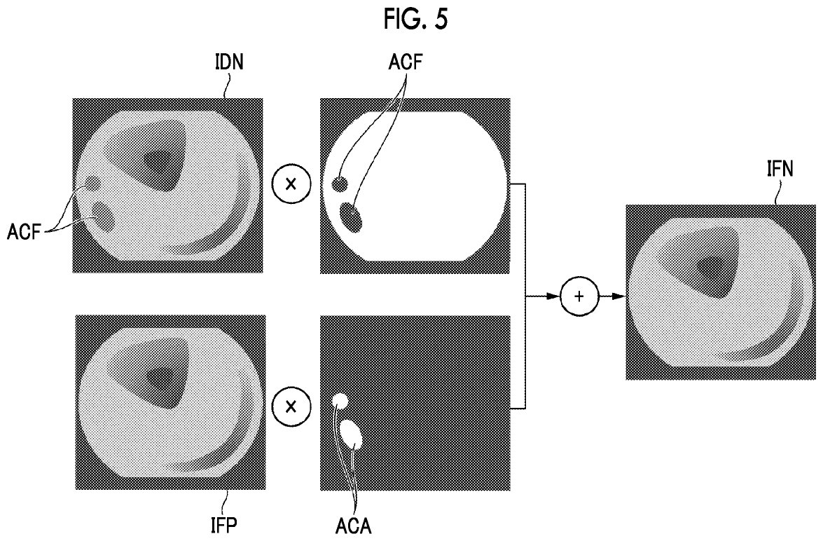

FIG. 5 is a schematic diagram illustrating an example of pixel replacement processing. In the pixel replacement processing, the pixel of the artifact region ACF estimated by performing the similarity comparison processing on the denoise image IDN is replaced with the pixel of the artifact corresponding region ACA in the noise filter processing image IFP corresponding to the artifact region ACF. Smoothing processing may be performed on a peripheral edge portion of the artifact corresponding region ACA. In FIG. 5, the artifact corresponding region ACA is schematically shown as a white pixel of the binarized image.

A pixel position of an artifact corresponding region ACA in the noise filter processing image IFP is understood based on information on pixel positions of the artifact region ACF in the denoise image IDN and the correspondence information between the pixel positions of both.

That is, in the pixel replacement processing, the pixel of the artifact corresponding region ACA in the noise filter processing image IFP is synthesized with the pixel of the normal region in the denoise image IDN, and the final image data representing the final image IFN is generated. The normal region in the denoise image IDN represents a region other than the artifact region ACF of the denoise image IDN. The final image generation unit 26 shown in FIG. 1 generates a final image IFN from final image data.

For example, a composite image in which the pixels of the artifact region ACF of the denoise image IDN are replaced with the pixels of the RAW image IRW is clearly unnatural due to a difference in noise level between the RAW image IRW and the denoise image IDN.

Therefore, the pixels of the noise filter processing image IFP generated by using a noise removal filter such as a Gaussian filter and a median filter are used for replacing the pixels of the artifact region ACF in the denoise image IDN. As a result, the occurrence of unnaturalness caused by the replacement of the pixels of the artifact region ACF in the denoise image IDN is suppressed.

It is preferable that, in an aspect, smoothing processing be performed on a peripheral edge portion of the region of the denoise image IDN that has been replaced with pixels of the noise filter processing image IFP. As a result, a sudden change in pixel value at a boundary portion between a region in which the pixel of the denoise image IDN is used and a region in which the pixel is replaced with the pixel of the noise filter processing image IFP is suppressed, which contributes to the generation of a natural denoise image IDN.

### Procedure of Image Processing Method According to First Embodiment

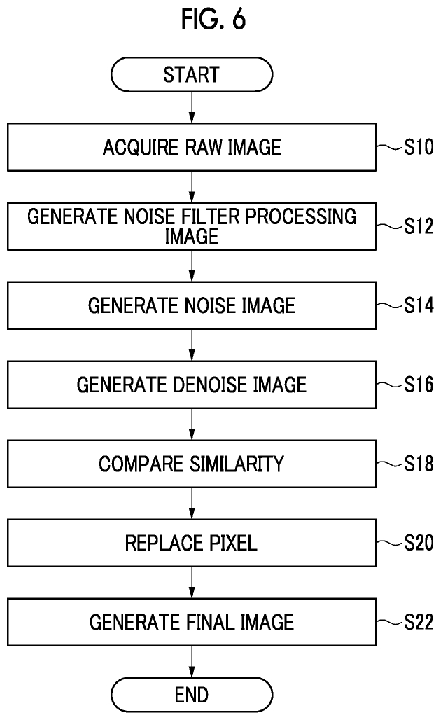

FIG. 6 is a flowchart showing a procedure of an image processing method according to the first embodiment. In Step S10, the RAW image acquisition unit 12 shown in FIG. 1 acquires a RAW image IRW. In Step S12, the noise filter processing image generation unit 14 performs filter processing of removing the noise component on the RAW image IRW to generate a noise filter processing image IFP in which the noise component is removed from the RAW image IRW.

In Step S14, the noise image generation unit 16 applies the first learning model 18 to generate a noise image INZ from which the noise component NIZ of the RAW image IRW is extracted. Step S14 may be executed after Step S18 and before Step S20, and may be executed in parallel with the series of steps including Step S16 and Step S18.

In Step S16, the denoising processing unit 20 performs processing of removing the noise component NIZ, which has been extracted as a noise image INZ from the RAW image IRW, from the RAW image IRW, and generates a denoise image IDN.

In Step S18, the similarity comparison unit 22 compares similarity between the denoise image IDN and the RAW image IRW, and estimates, as an artifact region ACF, a region in which pixel-wise differences of pixel values between the RAW image IRW and the denoise image IDN are relatively large. In Step S18, dissimilarity between the denoise image IDN and the RAW image IRW may be compared, and pixels whose dissimilarity between the two is greater than a criterion may be estimated as pixels included in the artifact region ACF.

In Step S20, the pixel replacement unit 24 replaces the pixel of the artifact region ACF in the denoise image IDN with the pixel of the noise filter processing image IFP. As the pixel of the noise filter processing image IFP, a pixel of the artifact corresponding region ACA in the noise filter processing image IFP corresponding to the position of the artifact region ACF of the denoise image IDN is used.

In Step S22, the final image generation unit 26 generates a final image IFN from data in which the pixel of the artifact region ACF in the denoise image IDN is replaced with the pixel of the artifact corresponding region ACA in the noise filter processing image IFP. A step of displaying the final image IFN generated in Step S22 on a monitor and a step of storing the final image IFN may be executed.

In the imaging of the inside of the body of the subject in which the endoscope apparatus is used, each of steps S10 to S22 shown in FIG. 6 is executed on the frame image of the moving image acquired by applying a prescribed imaging cycle.

The image processing method including steps S10 to S22 may be performed on all frame images constituting the moving image, or may be performed on frame images for each of a plurality of frame counts. The frame count may be defined in accordance with display conditions of the monitor. The image processing method according to the first embodiment, in which the procedure is shown in FIG. 6, can be configured as a method of operating a medical image processing apparatus.

### Actions and Effects of First Embodiment

The image processing apparatus 10 and the image processing method according to the first embodiment can obtain the following actions and effects.
1

The noise filter processing image generation unit 14 performs the filter processing on the RAW image IRW to generate a noise filter processing image IFP in which the noise component NIZ of the RAW image IRW is removed. A noise image INZ in which the noise component NIZ of the RAW image IRW is extracted is generated by using the trained first learning model 18. A denoise image IDN in which the noise component NIZ represented by the noise image INZ is removed from the RAW image IRW is generated by using the denoising processing unit 20.

The similarity comparison processing between the RAW image IRW and the denoise image IDN is performed by using the similarity comparison unit 22, and the artifact region ACF in the denoise image IDN is estimated. The pixels of the artifact region ACF in the denoise image IDN are replaced with the pixels of the artifact corresponding region ACA in the noise filter processing image IFP by using the pixel replacement unit 24. As a result, occurrences of artifacts in the denoise image IDN caused by the noise image INZ generated by using the trained first learning model 18 are suppressed.

In addition, the pixels of the artifact corresponding region ACA of the noise filter processing image IFP are used for replacing the pixels of the artifact region ACF of the denoise image IDN. Accordingly, the occurrence of unnaturalness in the denoise image IDN on which the pixel replacement processing is performed is suppressed.
2

In the similarity comparison processing, the threshold value processing is applied to the pixel-wise difference between the denoise image IDN that includes the artifact region ACF and the RAW image IRW. Accordingly, the difference exceeding the prescribed threshold value is extracted as the artifact region ACF of the denoise image IDN.
3

The contraction processing and the expansion processing are performed in this order on the difference between the denoise image IDN and the RAW image IRW. Accordingly, the noise component NIZ extracted in the difference can be removed.
4

In the denoise image IDN, the smoothing processing is performed on a region that has been replaced with pixels of the noise filter processing image IFP. Accordingly, a sudden change in the pixel value in the peripheral edge portion of the region in which the pixel replacement is performed is suppressed.
5

The noise filter processing image IFP and the denoise image IDN are generated based on the RAW image IRW. Differences in degrees of emphasis and differences in color for each operator are reflected in the two-dimensional image and the three-dimensional image generated from the RAW image. There are many variations in the noise filter processing image IFP and the denoise image IDN generated based on the two-dimensional image or the like, and it is difficult to uniquely generate the noise filter processing image IFP and the denoise image IDN. On the other hand, differences for each operator are not reflected in the RAW image. Accordingly, it is possible to uniquely generate the noise filter processing image IFP and the denoise image IDN.

Examples of the two-dimensional image or the like generated from the RAW image include a reconstructed image that is reconstructed based on the RAW image acquired from a camera provided in an endoscope. The reconstructed image reflects differences among operators and among facilities or the like.

### Configuration Example of Image Processing Apparatus According to Second Embodiment

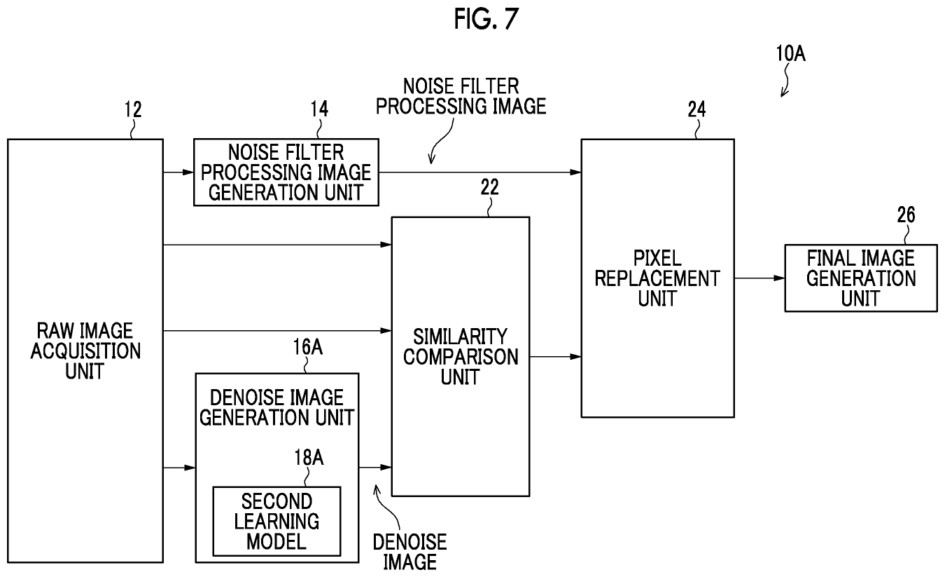

FIG. 7 is a functional block diagram showing a configuration example of an image processing apparatus according to a second embodiment. Hereinafter, mainly, the difference between the image processing apparatus 10 shown in FIG. 1 and an image processing apparatus 10A shown in FIG. 7 will be described, and the description of the common constituent elements of both will be omitted as appropriate.

In the image processing apparatus 10A, the denoise image IDN is directly generated from the RAW image IRW without generating the noise image INZ. That is, the image processing apparatus 10A comprises a denoise image generation unit 16A instead of the noise image generation unit 16 and the denoising processing unit 20 shown in FIG. 1.

The denoise image generation unit 16A comprises a second learning model 18A. The trained second learning model 18A is trained and generated such that the denoise image IDN is output in a case where the RAW image IRW is input. A learning model to which deep learning such as CNN is applied is applied to the second learning model 18A, as in the first learning model 18 shown in FIG. 1.

### Procedure of Image Processing Method According to Second Embodiment

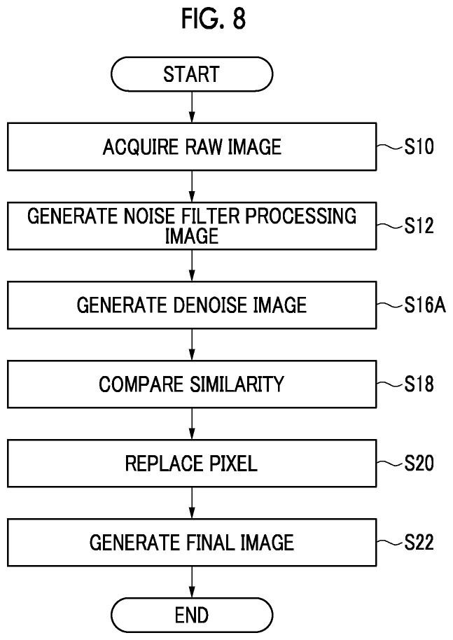

FIG. 8 is a flowchart showing a procedure of an image processing method according to the second embodiment. In the procedure of the image processing method according to the second embodiment shown in FIG. 8, Step S14 of generating a noise image in the procedure of the image processing method shown in FIG. 6 is omitted. In addition, in the procedure of the image processing method shown in FIG. 8, Step S16A of generating a denoise image IDN from the RAW image IRW is executed instead of Step S16 of generating the denoise image IDN shown in FIG. 6.

In the procedure shown in FIG. 8, Step S10 and Step S12 are executed as in the procedure shown in FIG. 6. In Step S16A, the denoise image generation unit 16A shown in FIG. 7 generates the denoise image IDN from the RAW image IRW by using the trained second learning model 18A. Next, Step S18, Step S20, and Step S22 are executed in the same manner as in the procedure shown in FIG. 6, and the final image IFN is generated. Step S16A may be an example of a step in which the second processing of the same type as the first processing of the present disclosure is performed.

The similarity comparison processing, the contraction and expansion processing, and the pixel replacement processing applied to the image processing apparatus 10A and the image processing method according to the second embodiment are similar to the similarity comparison processing and the like applied to the image processing apparatus 10 and the like according to the first embodiment.

### Actions and Effects of Second Embodiment

The image processing apparatus 10A and the image processing method according to the second embodiment can obtain the same actions and effects as the image processing apparatus 10 and the like according to the first embodiment. In addition, compared with the image processing apparatus 10 and the like according to the first embodiment, the constituent elements for generating the denoise image IDN from the RAW image IRW are simplified, and a reduction in the processing load is expected.

### Configuration Example of Image Processing Apparatus According to Third Embodiment

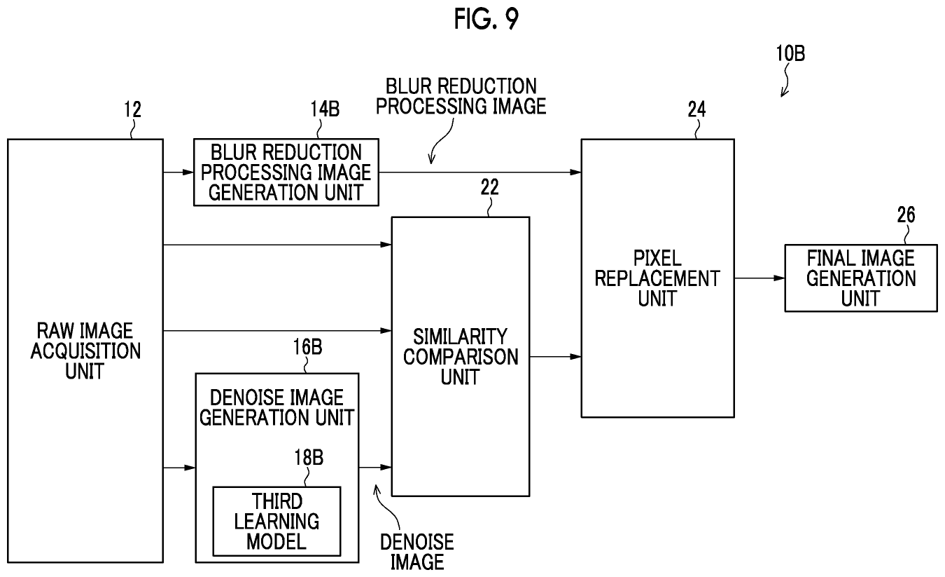

FIG. 9 is a functional block diagram showing a configuration of an image processing apparatus according to a third embodiment. Hereinafter, mainly, the difference between the image processing apparatus 10A shown in FIG. 7 and an image processing apparatus 10B shown in FIG. 9 will be described, and the description of the common constituent elements of both will be omitted as appropriate.

The image processing apparatus 10B executes an image restoration task such as reduction of blur. That is, the image processing apparatus 10B comprises a blur reduction processing image generation unit 14B instead of the noise filter processing image generation unit 14 shown in FIG. 7.

The blur reduction processing image generation unit 14B performs blur reduction processing on the RAW image IRW and performs restoration processing on the blurriness region and the blur region included in the RAW image IRW. The blur reduction processing image generation unit 14B is an example of a processing unit that performs the first processing of the present disclosure.

In addition, the image processing apparatus 10B comprises a deblur image generation unit 16B instead of the denoise image generation unit 16A shown in FIG. 7. The deblur image generation unit 16B comprises a third learning model 18B.

The trained third learning model 18B is trained and generated such that the deblur image is output in a case where the RAW image IRW is input. A learning model to which deep learning such as CNN is applied is applied to the third learning model 18B, as in the second learning model 18A shown in FIG. 7. The deblur image generation unit 16B may be an example of a processing unit that performs second processing of a type common to the first processing of the present disclosure.

### Procedure of Image Processing Method According to Third Embodiment

The image processing method according to the third embodiment includes a step of performing the blur reduction processing on the RAW image by the blur reduction processing image generation unit 14B shown in FIG. 9 to generate the blur reduction processing image, instead of Step S12 in the procedure shown in FIG. 8.

The image processing method according to the third embodiment also includes a step in which the deblur image generation unit 16B generates a deblur image from the RAW image using the trained third learning model 18B, instead of Step S16A shown in FIG. 8.

In Step S18, the RAW image IRW and the deblur image are compared with each other for each pixel, and the artifact region ACF in the deblur image is estimated. In Step S20, the pixel of the artifact region ACF in the deblur image is replaced with the pixel of the artifact corresponding region ACA in the blur reduction processing image.

The similarity comparison processing, the contraction and expansion processing, and the pixel replacement processing applied to the image processing apparatus 10B and the image processing method according to the third embodiment are similar to the similarity comparison processing and the like applied to the image processing apparatus 10A and the like according to the second embodiment.

### Actions and Effects of Third Embodiment

In the image processing apparatus 10B and the image processing method according to the third embodiment, the occurrence of the artifacts in the deblur image generated from the RAW image IRW by using the third learning model 18B is suppressed.

### Example of Hardware Configuration of Image Processing Apparatus

FIG. 10 is a block diagram showing an example of a hardware configuration of the image processing apparatus. As the image processing apparatus 10, one or more computers are applied. In the computer that functions as the image processing apparatus 10, a processor executes a program to realize various functions of the image processing apparatus 10. The hardware configuration shown in FIG. 10 is also applied to the image processing apparatus 10A shown in FIG. 7 and the image processing apparatus 10B shown in FIG. 9.

The computer may be a general-purpose computer such as a personal computer or a computer for a specific use such as a server computer. Any computer may be a system such as a workstation, or may be another hardware element capable of executing a program, such as a virtual machine.

At least some of functions of the image processing apparatus 10 may be realized by using cloud computing. At least some of the functions of the image processing apparatus 10 may be provided as SaaS. SaaS is an abbreviation for Software as a Service.

The image processing apparatus 10 comprises a processor 102, a computer-readable medium 104, a communication interface 106, an input and output interface 108, and a bus 110.

The processor 102 is connected to the computer-readable medium 104, the communication interface 106, the input and output interface 108, an input device 120, and the display device 122 via the bus 110.

The computer-readable medium 104 comprises a memory 112 as a main storage device and a storage 114 as an auxiliary storage device. The memory 112 includes a RAM. The memory 112 may include a ROM.

The storage 114 may be, for example, a hard disk drive, a solid state drive, or a combination of a plurality of these. In addition, the storage 114 may include an external storage device such as a removable medium.

RAM is an abbreviation for Random Access Memory, and ROM is an abbreviation for Read Only Memory. The hard disk drive may be referred to as HDD which is an abbreviation for Hard Disk Drive. The solid state drive may be referred to as an SSD which is an abbreviation for Solid State Drive.

The memory 112 stores a program, data, and the like for realizing various functions of the image processing apparatus 10. The processor 102 executes the program stored in the memory 112 to realize various functions. The processor 102 integrally controls each unit of the image processing apparatus 10 and performs various types of processing.

The communication interface 106 includes a communication interface that can be connected to an electric communication line such as a local area network. The communication interface 106 may be in a wireless format or may be in a wired format.

The input and output interface 108 includes a connection interface that can be connected to the external apparatus. As the connection interface that can be connected to the external apparatus, for example, a universal serial bus or HDMI (HDMI is a registered trademark) can be applied. HDMI is an abbreviation for High-Definition Multimedia Interface.

Examples of the input device 120 include a keyboard and a pointing device such as a mouse. The input device 120 may include a numeric keypad, various switch buttons, or the like. The input device 120 may include a voice input device. The input device 120 may be a touch panel type input device that is integrally configured with the display screen of the display device 122.

The display device 122 may be a liquid crystal display, an organic EL display, or a projector. The display device 122 may be an appropriate combination of the liquid crystal display and the like. In addition to the captured image acquired by using the camera, various types of information are displayed on the display device 122. The display device 122 is used as a part of a user interface in a case of receiving input from the input device 120. The present disclosure is not limited to one display device 122, and a form of a multi-display comprising a plurality of display devices 122 can be used. The organic EL may be referred to as OEL which is an abbreviation for Organic Electro-Luminescence.

### Computer and Processor Applied to Each Processing

In the present embodiment, each processing is executed by any computer. In addition, any computer may perform the processing by a processor, a program, or a combination thereof. Any computer may be a general-purpose computer, a computer for a specific use, a system such as a workstation, or another hardware element capable of executing a program.

The processor may be composed of one or a plurality of pieces of hardware, and types of hardware are not limited. For example, the processor may be configured by using hardware such as a central processing unit (CPU), a micro processing unit (MPU), a programmable logic device such as a field programmable gate array (FPGA), a dedicated circuit for executing specific processing such as an application-specific integrated circuit (ASIC), a graphic processing unit (GPU), or a neural processing unit (NPU). In addition, the processor has each unit or each means that executes various types of processing in the present embodiment. Furthermore, the types of hardware may be a combination of different types of hardware. In a case in which the plurality of types of hardware are configured to execute one or a plurality of types of processing of a certain processor, the plurality of types of hardware may be present in devices physically separated from each other or may be present in the same device. Furthermore, in any of the embodiments, the order of each processing performed by the processor is not limited to the above order, and may be changed as appropriate. The hardware is configured by an electric circuit (circuitry) in which circuit elements, such as semiconductor elements, are combined, or the like.

Further, the present embodiment may be realized by hardware, software, firmware, microcode, or a combination thereof. Software, firmware, and microcode are composed of a program. Furthermore, the program may be, for example, a program module group, and each function thereof may be implemented by the processor configured to execute each function. The program may be a program code or a plurality of code segments stored in one or a plurality of non-transitory computer-readable media (for example, a storage medium and other storages). The program may be divided and stored in a plurality of non-transitory computer-readable media present in apparatuses physically separated from each other. The program code or the code segment may represent any combination of procedures, functions, subprograms, routines, subroutines, modules, software packages, classes, instructions, data structures, or program statements. The program code or the code segments may be connected to other code segments or hardware circuits by transmitting and receiving information, data, an argument, a parameter, or content of a memory.

### Application Example to Program and Program Product

A program or program product for causing a computer to realize some or all of various functions of the image processing apparatus 10 and the like according to the embodiment may be stored in a computer-readable medium that is a non-transitory information storage medium being a tangible object such as an optical disk, a magnetic disk, or a semiconductor memory, and the program or program product may be provided through the information storage medium.

Instead of an aspect in which a program is stored in the above-described non-transitory computer-readable medium being a tangible object and applied, a program signal may also be provided as a download service by using a telecommunication line.

The present disclosure is not limited to the above-mentioned embodiment, and various modifications are possible within the scope of the technical concept of the present disclosure without departing from its gist. In addition, each of the first embodiment, the second embodiment, and the third embodiment can be combined as appropriate.

### EXPLANATION OF REFERENCES

10: image processing apparatus
10A: image processing apparatus
10B: image processing apparatus
12: RAW image acquisition unit
14: noise filter processing image generation unit
14B: blur reduction processing image generation unit
16: noise image generation unit
16A: denoise image generation unit
16B: deblur image generation unit
18: first learning model
18A: second learning model
18B: third learning model
20: denoising processing unit
22: similarity comparison unit
24: pixel replacement unit
26: final image generation unit
102: processor
104: computer-readable medium
106: communication interface
108: input and output interface
110: bus
112: memory
114: storage
120: input device
122: display device
ACA: artifact corresponding region
ACF: artifact region
IB: binarized image
IBB: binarized image
IBC: binarized image
IDN: denoise image
IFN: final image
IFP: noise filter processing image
INZ: noise image
IRW: RAW image
NIZ: noise component
S10 to S22: each step of image processing method

What is claimed is:

1. An image processing apparatus comprising a processor,
wherein the processor is configured to:
perform first processing, which does not use a trained learning model, on first image data to generate second image data;
perform second processing, which includes processing to which the trained learning model is applied, on the first image data to generate third image data;
compare similarity or dissimilarity between the first image data and the third image data; and
replace, in the third image data, a non-similar pixel whose similarity to the first image data is smaller than a criterion or whose dissimilarity from the first image data is greater than the criterion, with a pixel at a position corresponding to the non-similar pixel in the second image data.

2. The image processing apparatus according to claim 1,
wherein the processor is configured to:
compare similarity or dissimilarity between the first image data and the third image data based on a pixel-wise difference between the first image data and the third image data.

3. The image processing apparatus according to claim 2,
wherein the processor is configured to:
perform fourth processing of applying a prescribed threshold value to the difference between the first image data and the third image data; and
compare similarity or dissimilarity between the first image data and the third image data based on the difference subjected to the fourth processing.

4. The image processing apparatus according to claim 1,
wherein the processor is configured to: as the second processing,
apply a first learning model as the learning model to generate fourth image data from the first image data; and
remove a component corresponding to the fourth image data from the first image data to generate the third image data.

5. The image processing apparatus according to claim 4,
wherein the processor is configured to:
generate noise image data in which a noise component is extracted from the first image data as the fourth image data; and
generate the third image data by removing a component corresponding to the noise image data from the first image data.

6. The image processing apparatus according to claim 1,
wherein the processor is configured to:
apply a second learning model as the learning model to generate the third image data from the first image data.

7. The image processing apparatus according to claim 6,
wherein the processor is configured to:
apply the second learning model to generate the third image data from which a noise component is removed from the first image data.

8. The image processing apparatus according to claim 1,
wherein the processor is configured to:
apply a third learning model to generate the third image data in which blur is restored from the first image data.

9. The image processing apparatus according to claim 1,
wherein the processor is configured to:
apply filter processing as the first processing.

10. The image processing apparatus according to claim 1,
wherein the processor is configured to:
apply RAW image data as the first image data.

11. An image processing method executed by a computer functioning as an image processing apparatus including a processor, the method comprising:
a step of performing first processing, which does not use a trained learning model, on first image data to generate second image data;
a step of performing second processing, which includes processing to which the trained learning model is applied, on the first image data to generate third image data;
a step of comparing similarity or dissimilarity between the first image data and the third image data; and
a step of replacing, in the third image data, a non-similar pixel whose similarity to the first image data is smaller than a criterion or whose dissimilarity from the first image data is greater than the criterion, with a pixel at a position corresponding to the non-similar pixel in the second image data.

12. A non-transitory, computer-readable tangible recording medium on which a program is recorded, the program causing a computer functioning as an image processing apparatus including a processor to realize:
a function of performing first processing, which does not use a trained learning model, on first image data to generate second image data;
a function of performing second processing, which includes processing to which the trained learning model is applied, on the first image data to generate third image data;
a function of comparing similarity or dissimilarity between the first image data and the third image data; and
a function of replacing, in the third image data, a non-similar pixel whose similarity to the first image data is smaller than a criterion or whose dissimilarity from the first image data is greater than the criterion, with a pixel at a position corresponding to the non-similar pixel in the second image data.
